(19) United States
(12) Patent Application Publication
(10) Pub. No.: US 2002/0083236 A1
(43) Pub. Date: Jun. 27, 2002

(54) Cellular telephone data editing method

(76) Inventor: Shun-Ping Wang, Taipei Hsieng (TW)

Correspondence Address: BACON & THOMAS, PLLC, 4th Floor, 625 Slaters Lane, Alexandria, VA, 22314-1176, US

(21) Appl. No.: 09/741,060

(22) Filed: Dec. 21, 2000

(51) Int. Cl. G06F 13/10

(52) U.S. Cl. 710/62

(57) ABSTRACT

A cellular telephone data editing method includes the steps of: (a) converting the data of the cellular telephone to be edited into text format data; (b) sending the text format data thus obtained from the cellular telephone to a computer through a transmission cable; (c) operating an editing software of the computer to edit the text format data and then sending the edited data back to the cellular telephone through the transmission cable; and (d) controlling the processor of the cellular telephone to store edited data in the original location.

### BACKGROUND OF THE INVENTION

(a) Field of the Invention

The present invention relates to a cellular telephone data editing method, which converts the data of the cellular telephone into text format data, and then sends the text format data to a computer for editing through editing software. After editing, the edited data is sent back to the cellular telephone by the computer.

(b) Description of the Prior Art

When updating the data of a cellular telephone or adding new data to a cellular telephone, the user must operate the buttons of the cellular telephone to enter the desired catalog, and then to input data into the assigned catalog by means of the processing of a built-in software of the cellular telephone. Because the number of buttons of the cellular telephone is limited and the size of the buttons is small, it is difficult and takes much time to run a data updating operation. More particularly when inputting Chinese data, the speed is slow. In order to eliminate these problems, a computer or PDA (personal data assistant) may be used and connected to the cellular telephone to update the data of the cellular telephone or to add new data to the cellular telephone. In this case, the data and compatible software of the cellular telephone must be stored in advance in the memory space of the computer or PDA. This operating procedure is complicated and takes much time.

### SUMMARY OF THE INVENTION

The present invention has been accomplished to provide a cellular telephone data editing method, which eliminates the aforesaid drawbacks. According to one aspect of the present invention, the cellular telephone data editing method includes the steps of: (a) converting the data of the cellular telephone to be edited into text format data; (b) sending the text format data thus obtained from the cellular telephone to a computer through a transmission cable; (c) operating an editing software of the computer to edit the text format data and then sending the edited data back to the cellular telephone through the transmission cable; and (d) controlling the processor of the cellular telephone to store edited data in the original location. According to another aspect of the present invention, The cellular telephone data editing method of claim 1, wherein the step (b) of sending the text format data thus obtained from the cellular telephone to a computer through a transmission cable includes the sub-steps of: (i) operating the processor of the cellular telephone to enter the editing software stored therein; (ii) operating a selector button of the cellular telephone to select and enter the catalog to be edited; (iii) converting the data under the selected catalog and the location of the selected catalog into text format data; (iv) detecting the connection of the transmission cable between the computer and the cellular telephone; and (v) sending the text format data from the cellular telephone to the computer through the transmission cable. According to still another aspect of the present invention, the step (c) of operating an editing software of the computer to edit the text format data and then sending the edited data back to the cellular telephone through the transmission cable further comprises the sub-steps of: (i) starting the operating system of the computer to load the data transmitted from the cellular telephone in an editing software upon receipt of the same; (ii) operating the editing software to edit the data; (iii) converting the edited data into text format data; and (iv) sending the text format data from the computer back to the cellular telephone through the transmission cable.

### BRIEF DESCRIPTION OF THE DRAWINGS

FIG. 1 illustrates the hardware arrangement of the present invention.

FIG. 2 is a flow chart showing the cellular telephone data transmitting procedure according to the present invention.

FIG. 3 is a flow chart showing the computer (or PDA) data receiving and transmitting procedure according to the present invention.

FIG. 4 is a flow chart showing the cellular telephone data receiving procedure according to the present invention.

### DETAILED DESCRIPTION OF THE PREFERRED EMBODIMENT

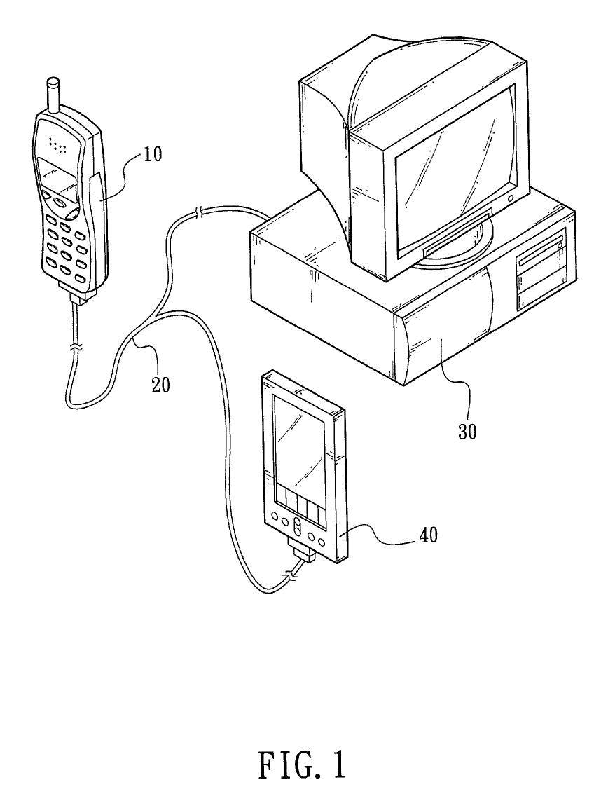

Referring to FIG. 1, a cellular telephone 10 is connected with a transmission cable 20. The other end of the transmission cable 20 is connec6ted to a RS232 series port of a computer 10 or PDA (personal data assistant) 40. According to the present preferred embodiment, the transmission cable 20 is connected to the computer 10. The cellular telephone 10 converts the data to be edited into text format, which is then transmitted to the computer 30 through the transmission cable 20 for editing by editing software, for example, WORD. After edition, the edited data is sent back to the cellular telephone 10 and stored in the previous location. By means of the aforesaid arrangement, it is not necessary to install editing software compatible to the cellular telephone 10, or to store all data of the cellular telephone 10 in the computer 30. Therefore, the invention saves much memory space of the computer 30 and data transmission time.

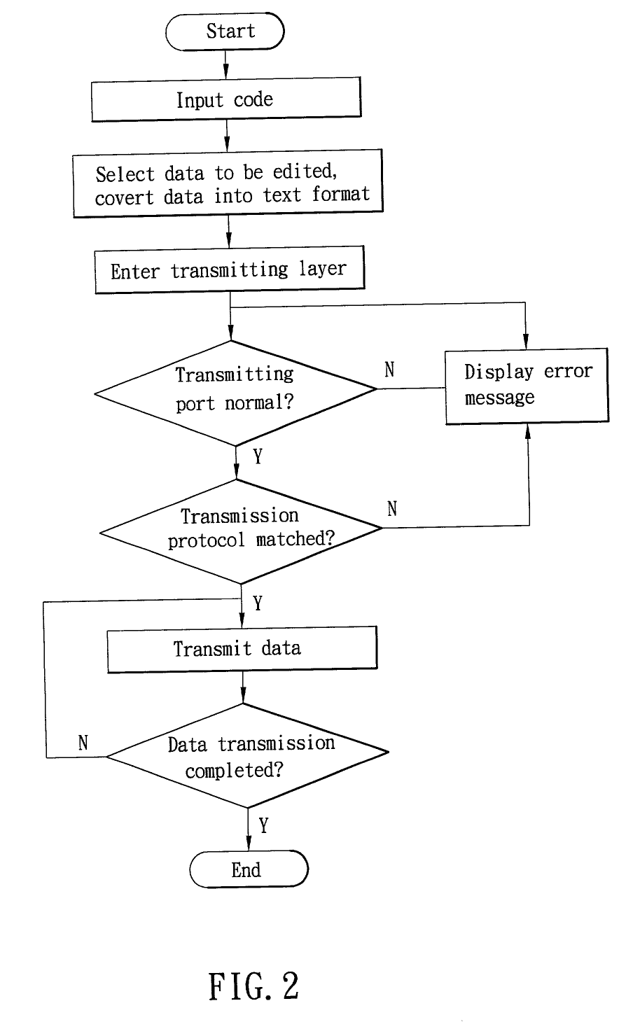

Referring to FIG. 2 and FIG. 1 again, when transmitting data, the processor of the cellular telephone 10 gets into the editing software installed therein to fetch all data, enabling fetched data to be shown on a display screen. When displayed, the user operates a selector button to select the catalog to be edited. After entered the selected catalog, the data under the selected catalog and the location of the selected catalog are converted into text format. Thereafter, it enters the transmission layer, enabling the processor of the cellular telephone 10 to detect normal transmission status (connection status to the computer 30) of the transmission port of the transmission layer. If not connected, the message is shown on the display screen, and at the same time the processor continues the detection action until the transmission port has been connected to the computer 30. When connected, the processor detects the uniformity of the transmission protocol between the cellular telephone 10 and the computer 30. If the transmission protocol between the cellular telephone 10 and the computer 30 does not match, the processor displays the message on the display screen, and then continues the detection action until the transmission protocol matches. When matched, the processor transmits the text format data from the cellular telephone 10 through the transmission cable 20 to the computer 30. During data transmission, the processor keeps detecting the transmission procedure until the end of the transmission work.

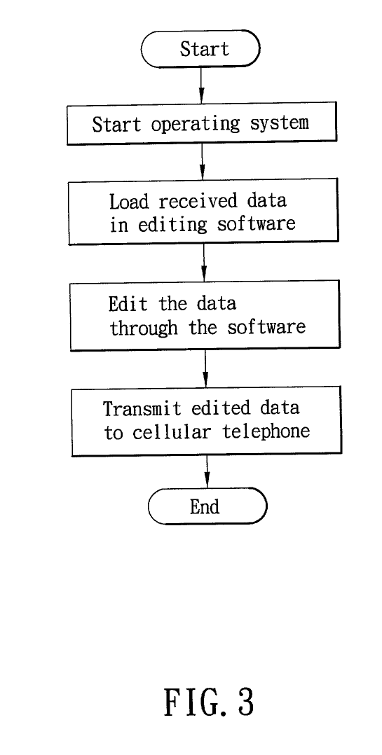

Referring to FIG. 3 and FIG. 1 again, upon receipt of the data from cellular telephone 10 through the transmission cable 20, the processor of the computer 30 starts the operation system to load the received data in editing software (for example, WORD) for editing. When edited, the processor of the computer 30 converts the edited data into text format, and then transmits the text format data back to the cellular telephone 10 through the transmission cable 20.

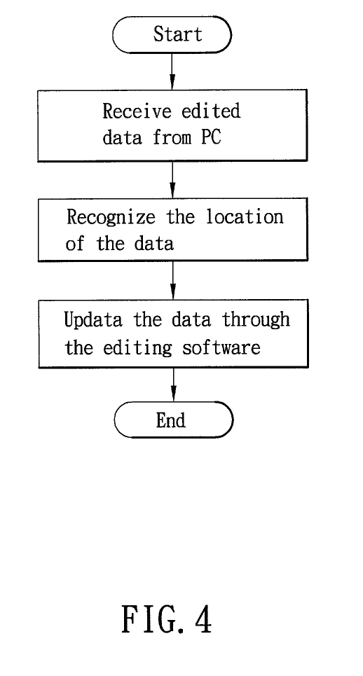

Referring to FIG. 4 and FIG. 1 again, upon receipt of the text format data from the computer 30, the processor of the cellular telephone 10 recognizes the location of the data, and then runs the updating action to store the edited data in the location.

In an application example of correcting company data built in the communication catalog, the procedure is outlined hereinafter. At first, connect the cellular telephone to the computer by the transmission cable, and then operate the selector button to enter the company catalog under the communication catalog, and then convert all data under the company catalog into text format and represent the catalog of every layer by “-”, and then send the text format data to the computer, and then use WORD to edit the data, and then transmit the edited data from the computer to the cellular telephone and store it in the original location to complete the operation of data auto-updating.

What the invention claimed is:

1. A cellular telephone data editing method comprising the steps of:
(a) converting the data of the cellular telephone to be edited into text format data;
(b) sending the text format data thus obtained from the cellular telephone to a computer through a transmission cable;
(c) operating an editing software of the computer to edit the text format data and then sending the edited data back to the cellular telephone through the transmission cable; and
(d) controlling the processor of the cellular telephone to store edited data in the original location.

2. The cellular telephone data editing method of claim 1, wherein the step (b) of sending the text format data thus obtained from the cellular telephone to a computer through a transmission cable includes the sub-steps of:
(i) operating the processor of the cellular telephone to enter the editing software stored therein;
(ii) operating a selector button of the cellular telephone to select and enter the catalog to be edited;
(iii) converting the data under the selected catalog and the location of the selected catalog into text format data;
(iv) detecting the connection of the transmission cable between the computer and the cellular telephone; and
(v) sending the text format data from the cellular telephone to the computer through the transmission cable.

3. The cellular telephone data editing method of claim 2, wherein if the connection of the transmission cable between the computer and the cellular telephone is abnormal during the sub-step (iv) of detecting the connection of the transmission cable between the computer and the cellular telephone, the processor of the cellular telephone shows the message on the display screen of the cellular telephone and at the same time continues the detection operation.

4. The cellular telephone data editing method of claim 1, wherein the step (c) of operating an editing software of the computer to edit the text format data and then sending the edited data back to the cellular telephone through the transmission cable further comprises the sub-steps of:
(i) starting the operating system of the computer to load the data transmitted from the cellular telephone in an editing software upon receipt of the same;
(ii) operating the editing software to edit the data;
(iii) converting the edited data into text format data; and
(iv) sending the text format data from the computer back to the cellular telephone through the transmission cable.

5. The cellular telephone data editing method of claim 1, wherein the step (d) of controlling the processor of the cellular telephone to store edited data in the original location comprises the sub-steps of:
(i) driving the processor of the cellular telephone to recognize the location of the data received, and
(j) proceeding to auto-updating action to store the data into the recognized location.
